(19) United States
(12) Patent Application Publication
(10) Pub. No.: US 2010/0046604 A1
(43) Pub. Date: Feb. 25, 2010

(54) METHOD AND SYSTEM FOR IMPROVING CHANNEL ACQUISITION PERFORMANCE

(75) Inventor: Erik Elstermann, Carlsbad, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/194,722

(22) Filed: Aug. 20, 2008

(51) Int. Cl. H04B 1/66

(52) U.S. Cl. 375/240.01; 375/E07.001

(57) ABSTRACT

A method and system for processing a video program are disclosed. For example, the method receives a video program. The method receives a delayed version of the video program. The method decodes the delayed version of the video program until a corresponding anchor frame is found in the video program and in the delayed version of the video program. The method concludes by switching from decoding the delayed version of the video program to decoding the video program beginning with the corresponding anchor frame.

### FIELD OF THE INVENTION

The present invention relates generally to channel acquisition and, in particular, improving channel acquisition performance when a viewer changes a channel.

### BACKGROUND OF THE INVENTION

One limitation on the speed of acquisition and rendering of digitally compressed video in broadcast networks is the pace or frequency of anchor frames and the bandwidth available to deliver data to a set top box. The anchor frames provide random access points to a video program that a viewer may wish to view by changing a channel on the set top box. For example, when the viewer changes a channel on the set top box, the viewer may experience a noticeable delay between a video program displayed on a previous channel and display of a video program associated with the currently selected channel. Usually, this appears to the viewer as a blank screen.

### BRIEF DESCRIPTION OF THE DRAWINGS

The teaching of the present invention can be readily understood by considering the following detailed description in conjunction with the accompanying drawings, in which:

FIG. 1 illustrates a high level block diagram of an exemplary architecture of the present invention;

FIG. 2A illustrates an exemplary time line diagram depicting a method for improving channel acquisition performance;

FIG. 2B illustrates an alternate exemplary time line diagram depicting an alternate method for improving channel acquisition performance;

FIG. 3 illustrates a first exemplary flow chart depicting a method for improving channel acquisition performance; and

FIG. 4 illustrates a high level block diagram of an exemplary general purpose computer suitable for use in performing the functions described herein.

To facilitate understanding, identical reference numerals have been used, where possible, to designate identical elements that are common to the figures.

### DETAILED DESCRIPTION

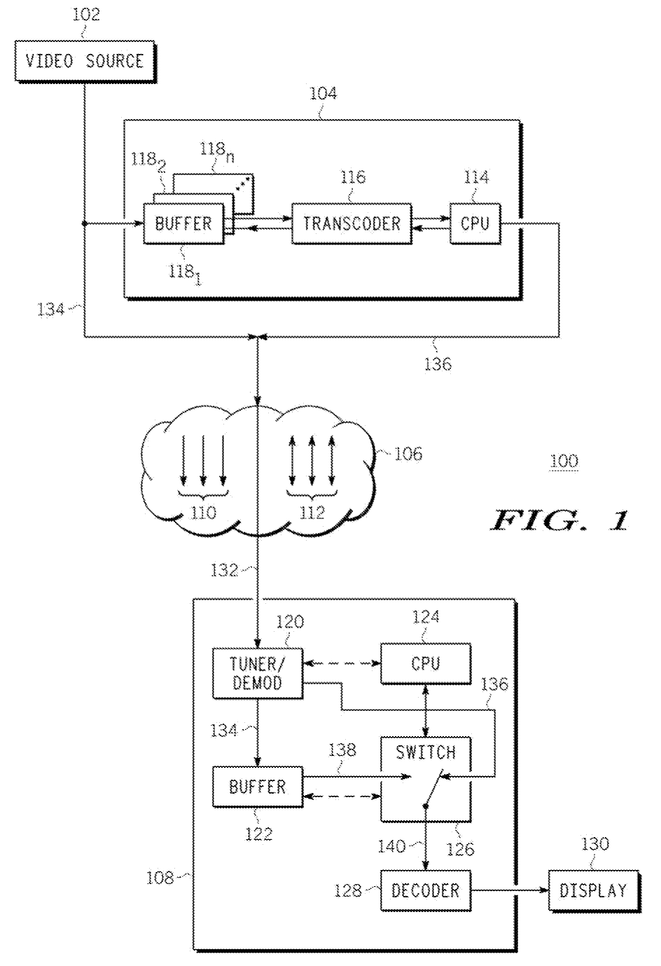

FIG. 1 illustrates a high level block diagram of an exemplary system 100 of the present invention. In an exemplary embodiment, system 100 includes a video source 102, a stream server 104, an access network 106 and a set top box 108.

The video source 102 may provide any type of digitally compressed video for viewers desiring to watch a video program on a display 130 via the set top box 108. For example, the digitally compressed video may be any type of digitally compressed video having anchor frames. For example, the digitally compressed video may be H.264, MPEG-2 or MPEG-4 video and the like. The anchor frames may be for example, “I” frames of an MPEG-2 compressed video. An anchor frame is broadly defined as a reference frame from which a decoder will need to properly decode other encoded frames (e.g., B frames). In an exemplary embodiment, the video source may be located at a head end of a cable television provider.

When a viewer using the set top box 108 watches a video program on the display 130, the video program is transmitted on a program stream 134 from the video source 102 through the access network 106 on one or more broadcast channels 110 via a transport stream 132 to the set top box 108. The program stream 134 carrying the video program is provided to a tuner/demodulator 120, a buffer 122 and a decoder 128 in the set top box 108. It should be noted that transport stream 132 may be carrying a plurality of video programs. Moreover, the set top box 108 may be tuned to only a particular video program at a given time.

Currently, when the viewer decides to change a channel to a different video program, there is a noticeable delay due to the way digitally compressed video programs are acquired. For example, the decoder 128 must wait for an anchor frame in order to render the video program on the newly selected channel.

To resolve this issue, in an exemplary embodiment of the present invention the video program on stream 134 is simultaneously fed into a stream server 104. Within the stream server 104, the video program is buffered and then output as a delayed version of the video program via a stream 136. The video program on stream 134 and the delayed version of the video program 136 are transmitted simultaneously over the access network 106 on the transport stream 132 to the set top box 108. Alternatively, the video program on stream 134 and the delayed version of the video program 136 may be transmitted over different access networks and different transport streams (not shown) if the set top box 108 employs multiple tuner/demodulators 120.

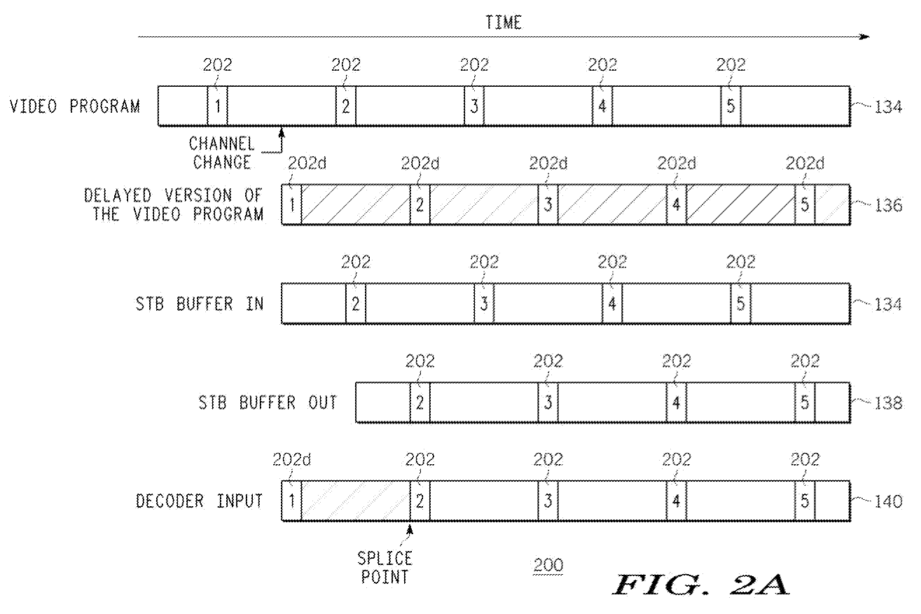

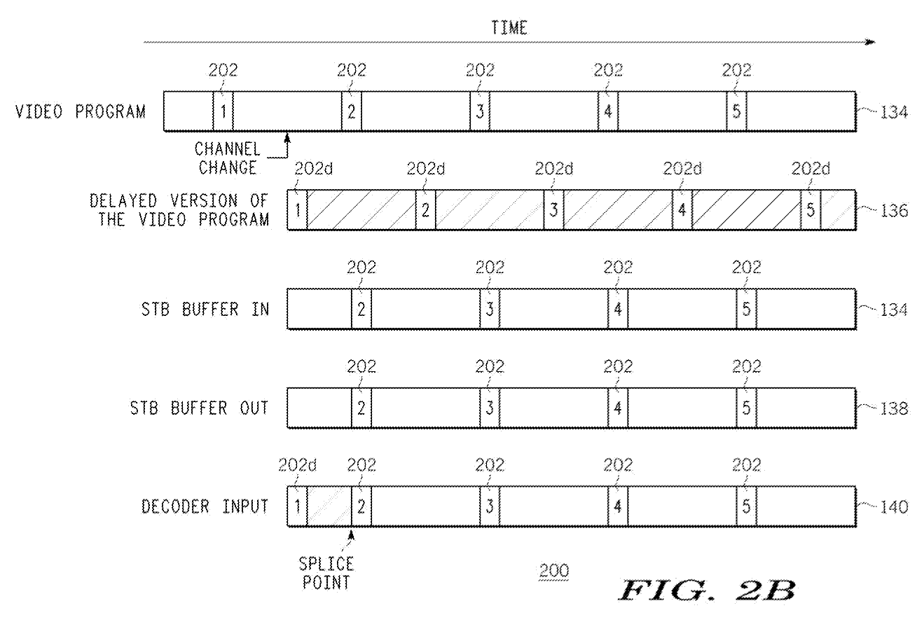

Notably, the video program and the delayed version of the video program are identical in content. In other words, the video program and the delayed version of the video program have identical anchor frames with an identical frequency of anchor frames. In addition, all the data contained in between the anchor frames are also identical. However, the delayed version of the video program is simply time shifted. This will be discussed in further detail with respect to FIG. 2.

When a viewer changes the channel, the most recently received anchor frame in the delayed version of the newly selected video program may be provided faster because of the buffering performed at the stream server 104. More specifically, the anchor frames would have been identified by stream server 104 and provided to the set top box 108 first since the stream server 104 had time to process the video programs to generate the delayed version of the video programs. At the set top box 108, the newly selected video program is fed to the tuner/demodulator 120. The delayed version of the video program is fed to switch 126 and to the decoder 128 via stream 140. A processor 124 will cause the delayed version of the newly selected video program beginning with a first anchor frame to be played until a corresponding second or subsequent anchor frame is found in the video program carried on stream 134. It should be noted that, the video program carried on stream 134 is being stored in buffer 122 and can be presented as stream 138 to decoder 128. When the processor 124 finds the second anchor frame in the video program, the processor 124 instructs the switch 126 to feed the decoder 128 the video program on stream 138 exactly at the point the second anchor begins. In other words, once the proper anchor frame is located in the video program stored in buffer 122, the set top box 108 will switch over to decoding and displaying the video program stored in buffer 122. Those skilled in the art will recognize that switch 126 may be a physical switch or a switch implemented by a software application.

The remaining portion of the video program may then be decoded from the video program on streams 134 and 138 and all resources used to transport the delayed version of the video program on stream 136 may be released. The CPU 124 of the set top box 108 communicates with the stream server 104 to create and teardown the stream 136 as needed. If resources, such as processing power, bandwidth and the like, are unavailable to generate and transport stream 136, the system would remain operational with degraded channel change performance as currently used today.

As discussed above, the delayed version of the video program is generated via stream server 104. The stream server 104 may be located, for example, at a head end or a hub of a cable television provider. The stream server 104 may service multiple viewers simultaneously on a plurality of channels.

In one embodiment, the stream server 104 comprises a plurality of buffers (e.g. circular buffers) 118₁, 118₂ . . . 118ₙ, a transcoder 116 and a processor (e.g. a central processing unit “CPU”) 114. The plurality of buffers 118₁, 118₂ . . . 118ₙ may be collectively referred to herein as buffers or as an individual buffer such as buffers 118 or buffer 118, respectively. Within the stream server 104, there may be at least one buffer 118 for each programming channel. Although one embodiment of the stream server 104 is illustrated in FIG. 1 as comprising buffers 118, a transcoder 116 and a CPU 114, one skilled in the art will recognize that the buffers 118, the transcoder 116 and the CPU 114 may be in any order. For example, the stream server 104 may comprise a transcoder 116 first, buffers 118 and then a CPU 114.

Furthermore, in one embodiment, transcoder 116 can be implemented as an anchor frame identifier. Namely, if transcoding functions are not required in an implementation, then the stream server 104 can implement a less complex module which only needs to have the capability of identifying the anchor frames in the video programs.

Each buffer 118 may store a video program of a respective programming channel for up to a pre-defined period of time. In one embodiment, each buffer 118 may record all data received from the video source 102 by continuously writing all data received from the video source 102. For example, each buffer 118 may record frames of data (e.g. several groups of pictures (GOPs)) received from each respective channel received from the video source 102. Moreover, each buffer 118 may read data by moving a read pointer from reference frame (e.g., an “I” frame) to reference frame. In other words, the buffer 118 can only begin reading from a reference frame and, therefore, the read pointer must jump from one reference frame to another. Once the appropriate reference frame is read out of the buffer 118, all subsequent data is read continuously thereafter.

In an alternate embodiment, the buffer 118 may comprise a plurality of queues or registers in parallel alignment operated by a switch. The queues may operate in a first in first out (FIFO) fashion. A switch coupled to each queue on the input side and the output side determines which queue data is written into and which queue data is read out of. Those skilled in the art will recognize that there may be alternate ways to operate the buffers 118 and the present invention is not limited to the examples described above. Thus, when a viewer changes the channel the delayed version of the video program 136 is output by the buffer 118 beginning with the first available reference frame read from the buffer 118.

Subsequently, when a particular programming channel is desired, the processor 114 in the stream server 104 may obtain the appropriate delayed video program from one of the buffers 118. More specifically, the processor 114 may identify the appropriate buffer 118 storing the delayed video program corresponding to the particular programming channel that is desired and may instruct the appropriate buffer 118 to begin transmitting the delayed video program beginning with an anchor frame. The delayed video program is fed through the transcoder 116, which may perform one or more transcoding and/or decoding functions, e.g. identifying or detecting one or more anchor frames in the video program. For example, the transcoder 116 may transcode the frames in the delayed video programs into a lower resolution. Since the frames in the delayed video programs are only presented for a brief period of time during a channel change event, the reduced resolution frames will require less storage space and less transmission bandwidth. However, one skilled in the art will recognize that the video program for a respective channel may be transcoded first by transcoder 116 and then fed to the buffers 118, as discussed above. Thus, the order of operations described above should not be interpreted as limiting embodiments of the present invention.

It should be noted that although access network 106 is illustrated as one network the present invention is not so limited. Notably, in one embodiment, the access network 106 may comprise two different access networks or one access network with two different types of channels. For example, access network 106 may comprise a broadcasting channel 110 and an interactive channel 112. The broadcasting channel 110 may be, for example, a one way channel using a quadrature amplitude modulation (QAM) format typically used by cable television providers for providing video programming. The interactive channel 112 may be, for example, a two way channel using a data over cable services interface specification (DOCSIS) format on a cable modem termination system (CMTS) typically used by cable television providers for providing high speed internet services.

In one exemplary embodiment of the present invention, the delayed version of the video program carried via stream 136 may be transported via the interactive channel 112 of the access network 106. The video program carried via stream 134 may be transported via the broadcasting channel 110 of the access network 106. Therefore, as discussed above, when the switch 126 switches over to the video program on streams 134 and 138, the resources used by interactive channel 112 to carry the delayed version of the video program may be released for other use.

In another exemplary embodiment of the present invention, if the interactive channel 112 is not available to the viewer, the delayed version of the video program beginning with an anchor frame carried via stream 136 may also be transported via the broadcasting channel 110. However, the delayed version of the video program may be carried on a separate channel. For example, an unused programming channel or a programming channel reserved for future programming not currently in use may be used to carry the delayed version of the video program. Those skilled in the art will recognize that for digitally compressed video programming that multiple programs may in fact be carried on the same channel (i.e. a virtual channel). Notably, the video program and the delayed version of the video program may be simply sent to the set top box 108 as separate video programs on the same physical channel, but different virtual channels.

The requested video program carried on stream 134 would be transported on the appropriate programming channel (real or virtual) corresponding to a specific channel requested by the viewer. In this instance, the delayed version of the video program beginning with an anchor frame would first be fed to the decoder 128 via switch 126 on the unused programming channel. Subsequently, when the switch 126 switches over to the video program on stream 134, the resources used by the broadcasting channel 110 (i.e. the unused programming channel or the programming channel reserved for future programming) may be released for other use. One skilled in the art will recognize that any number of unused or future programming channels may be used to carry the delayed version of the video program. For example, there may be one unused or future programming channel for each current channel to deliver the delayed version of the video program.

An exemplary time line diagram 200 depicting a method for improving channel acquisition performance is illustrated in FIG. 2A. As illustrated by FIG. 2A, the time moves from left to right. As discussed above, a digitally compressed video program may comprise multiple anchor frames 202. The digitally compressed video program labeled “Video Program” represents the video program carried by stream 134. When a viewer changes a channel at the set top box 108, to display the video program of the newly selected channel, the processor 124 at the set top box 108 must cause the video program to be acquired and wait for the next available anchor frame 202. Depending on how far the anchor frames 202 are spaced apart, this may cause a considerable and noticeable delay to the viewer.

However, as illustrated by an exemplary embodiment of the present invention and discussed above, the video program carried by stream 134 may be provided simultaneously to the stream server 104 to create a delayed version of the video program. The stream labeled “Delayed Version of the Video Program” represents the delayed version of the video program carried by stream 136. As illustrated by time line diagram 200, the delayed version of the video program is time shifted slightly to the right of video program having anchor frames 202d. However, in every other respect, the delayed version of the video program is identical to the non-delayed video program, as discussed above. In other words, the delayed version of the video program may have the identical frequency of anchor frames 202d as the anchor frames 202 of the video program and contain the same data in between anchor frames 202d and 202.

As discussed above, when a viewer changes channels on the set top box 108, the set top box 108 may acquire the video program on the newly selected channel and access the video program in between anchor frames 202. The video program is then fed to a buffer 122 in the set top box 108 as illustrated by the video program 134 labeled “STB Buffer In”. Consequently, in previous methods of acquiring video programming on a newly selected channel, the set top box 108 would have to wait until the next anchor frame 202 was received to begin displaying the video program to the viewer.

In one embodiment, the present invention overcomes this problem by displaying the delayed version of the video programming with the delayed first anchor frame 202d as illustrated by the video program labeled “Decoder Input” representing the video program carried by stream 140. Then, when the processor 124 of the set top box 108 finds the next available anchor frame 202 in the video stream 138 labeled “STB Buffer Out” that corresponds to the current second anchor frame 202d of the delayed version of the video program, the processor 124 of the set top box 108 instructs the switch 126 to switch to the video program 138 beginning with the second anchor frame 202 of the “STB Buffer Out”. This is illustrated in FIG. 2A by the “Decoder Input” as the delayed version of the video program (hatched portion) is spliced and replaced with the video program (no hatches) beginning with the second anchor frame 202. As a result, little to no delay is noticed by the viewer and the new channel selected by the viewer appears to be acquired almost immediately. It should be noted that since the display rate for the video program was not changed by the set top box, the video program carried by stream 140 is actually slightly delayed relative to the reception time of the video program represented by stream 134.

In one embodiment, the CPU 124 of the set top box 108 is in communication with the CPU 114 of the stream server 104. The CPU 114 calculates an amount of delay introduced into the delayed version of the video program stored in a respective buffer 118. The amount of delay may be communicated to the CPU 124 in the set top box 108 such that the CPU 124 may instruct the buffer 122 in the set top box 108 on how much delay to introduce to the non-delayed version of the video program. Thus, at the splice point illustrated in FIG. 2A, the video program carried by stream 138 of the “STB Buffer Out” will be synchronized with delayed version of the video program 136 and a smooth transition will occur when the switch 126 is activated and no frames need be dropped or accelerated.

Those skilled in the art will recognize that there may be alternate methods to determining how much delay is needed in the set top box buffer 122. For example, the CPU 124 of the set top box 108 may simply calculate the necessary delay locally by calculating the time between the first data frame received at the buffer 122 and the first anchor frame received at the buffer 122. Subsequently, the set top box 108 may intermittently drop B and P frames between successive anchor frames 202 of the video program 134 up to an amount equal to the calculated delay. As a result, the anchor frames 202 of the video program 134 will eventually align in time with the delayed version of the video program 136. Thus, the present invention is not limited by the examples described above.

In one alternate embodiment, illustrated in FIG. 2B, the display rate for the video program can be changed by the set top box 108. More specifically, this alternate method will display the delayed version of the video programming with the delayed first anchor frame 202d as illustrated by the video program labeled “Decoder Input” representing the video program carried by stream 140. However, when the processor 124 of the set top box 108 finds the next available anchor frame 202 in the video stream “STB Buffer In” that corresponds to the second anchor frame 202 of the normal time version (i.e., undelayed version) of the video program 134, the processor 124 of the set top box 108 will instruct the switch 126 to switch to the video program beginning with the second anchor frame 202 of the “STB Buffer Out”. This is illustrated in FIG. 2B by the “Decoder Input” 140 as the delayed version of the video program (hatched portion) is spliced and replaced with the video program (no hatches) beginning with the second anchor frame 202. As a result, little to no delay is noticed by the viewer and the new channel selected by the viewer appears to be acquired almost immediately. However, as shown in FIG. 2B, the hatched portion of stream 140 is reduced relative to the hatched portion of stream 140 illustrated in FIG. 2A. In the embodiment of FIG. 2B, the video program carried by stream 140 is now in synchronization with the reception time of the video program represented by stream 134. Thus, changing the display rate for the video program will be required, e.g., accelerating the display rate of the delayed version of the video program or simply dropping some frames of the delayed version of the video program.

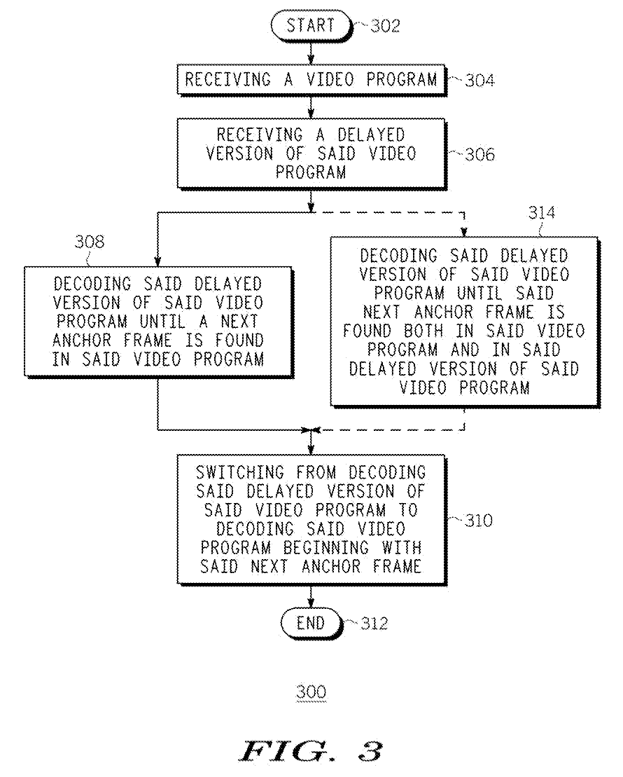

FIG. 3 illustrates a first exemplary flow chart depicting a method 300 for improving channel acquisition performance. For example, method 300 can be implemented in a set top box 108.

Method 300 begins at step 302. Then the method receives a video program at step 304. For example, the video program may be received over an access network 106.

Subsequently, at step 306 the method receives a delayed version of the video program. In one embodiment, the delayed version of the video program may be received via an interactive channel 112 of the access network 106. In an alternate embodiment, the delayed version of the video program may be received via a broadcast channel 110 of the access network 106. As discussed above, the delayed version of the video program is delayed by simultaneously feeding the video program through the stream server 104.

In one embodiment, the method proceeds to step 308. At step 308, the method decodes the delayed version of the video program until a next anchor frame is found in the video program. For example, the display rate for the video program may be changed or frames may be dropped as discussed above with reference to FIG. 2B.

In an alternate embodiment, the method may proceed to step 314. At step 314 the method decodes the delayed version of the video program until a next anchor frame is found in the video program and in the delayed version of the video program. As discussed above with reference to FIG. 2A, the method finds the anchor frame 202 in the video program that corresponds to the anchor frame 202d of the delayed version of the video program.

Either from step 308 or step 314, the method proceeds to step 310. At step 310, the method switches from decoding the delayed version of the video program to decoding the video program beginning with the next anchor frame. When the processor 124 in the set top box 108 determines that corresponding anchor frames have been found, the processor 124 may instruct the switch 126 to switch from feeding the decoder the delayed version of the video program on stream 136 to feeding the decoder the non-delayed video program on stream 138. The method concludes with step 312.

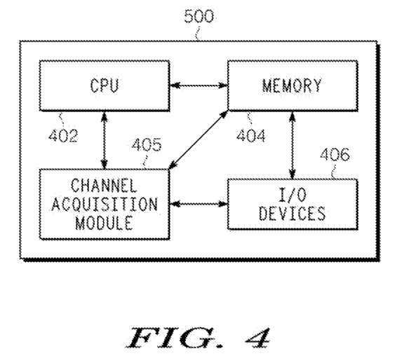

FIG. 4 illustrates a high level block diagram of an exemplary general purpose computer suitable for use in performing the functions described herein. As depicted in FIG. 4, the general purpose computer 400 comprises a processor element 402 (e.g., a CPU), a memory 404, e.g., random access memory (RAM) and/or read only memory (ROM), a channel acquisition module 405 for improving channel acquisition performance, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the processes provided by the present channel acquisition module 405 (e.g., discussed in method 300) can be loaded into memory 404 and executed by processor 402 to implement the functions as discussed above. As such, the processes provided by the channel acquisition module 405 for improving channel acquisition performance of the present invention can be stored on a computer readable medium or carrier, e.g., RAM memory, magnetic or optical drive or diskette and the like.

While the foregoing is directed to illustrative embodiments of the present invention, other and further embodiments of the invention may be devised without departing from the basic scope thereof, and the scope thereof is determined by the claims that follow.

What is claimed is:

1. A method of processing a video program, comprising:
receiving a video program;
receiving a delayed version of said video program;
decoding said delayed version of said video program until a next anchor frame is found in said video program; and
switching from decoding said delayed version of said video program to decoding said video program beginning with said next anchor frame.

2. The method of claim 1, wherein decoding said delayed version of said video program until a next anchor frame is found in said video program comprises:
dropping frames of said delayed version of said video program or accelerating a display of frames of said delayed version of said video program.

3. The method of claim 1, wherein said delayed version of said video program comprises said video program delayed through at least one buffer in a stream server.

4. The method of claim 3, wherein said at least one buffer begins reading data with an anchor frame.

5. The method of claim 4, wherein said stream server comprises a plurality of buffers, wherein each buffer corresponds to a programming channel.

6. The method of claim 5, wherein said at least one buffer stores said video program for a period of time.

7. A computer-readable medium having stored thereon a plurality of instructions, said plurality of instructions including instructions which, when executed by a processor, cause said processor to perform said steps of a method of processing a video program, comprising:
receiving a video program;
receiving a delayed version of said video;
decoding said delayed version of said video program until a next anchor frame is found in said video program; and
switching from decoding said delayed version of said video program to decoding said video program beginning with said next anchor frame.

8. The computer readable medium of claim 7, wherein decoding said delayed version of said video program until a next anchor frame is found in said video program comprises:
dropping frames of said delayed version of said video program or accelerating a display of frames of said delayed version of said video program.

9. The computer readable medium of claim 7, wherein said delayed version of said video program comprises said video program delayed through at least one buffer in a stream server.

10. The computer readable medium of claim 9, wherein said at least one buffer begins reading data with an anchor frame.

11. The computer readable medium of claim 10, wherein said stream server comprises a plurality of buffers, wherein each buffer corresponds to a programming channel.

12. The computer readable medium of claim 11, wherein said at least one buffer stores said video program for a period of time.

13. An apparatus for processing a video program, comprising:
a tuner for receiving a video program;
a decoder for receiving a delayed version of said video program, wherein said decoder decodes said delayed version of said video program until a next anchor frame is found in said video program; and
a switch for switching from decoding said delayed version of said video program to decoding said video program beginning with said corresponding second anchor frame.

14. The apparatus of claim 13, wherein said switch switches to said video program as soon as the next anchor frame is found in said video program by dropping frames or accelerating frames.

15. The apparatus of claim 13, wherein said delayed version of said video program comprises said video program delayed through at least one buffer in a stream server.

16. The apparatus of claim 15, wherein said at least one buffer begins reading data with an anchor frame.

17. The apparatus of claim 16, wherein said stream server comprises a plurality of buffers, wherein each buffer corresponds to a programming channel.

18. A method of processing a video program, comprising:
receiving a video program;
receiving a delayed version of said video program;
decoding said delayed version of said video program until said next anchor frame is found both in said video program and in said delayed version of said video program; and
switching from decoding said delayed version of said video program to decoding said video program beginning with said next anchor frame.

19. The method of claim 18, wherein a delay is introduced to said video program at a set top box.

20. The method of claim 19, wherein an amount of said delay is calculated at a stream server and communicated to said set top box.
